(19) United States
(12) Patent Application Publication
(10) Pub. No.: US 2017/0094494 A1
(43) Pub. Date: Mar. 30, 2017

(54) ACTIVE PROXIMITY BASED WIRELESS NETWORK COMMISSIONING

(71) Applicant: OSRAM SYLVANIA Inc., Wilmington, MA (US)

(72) Inventors: Bruce A.C. Douglas, Etobicoke (CA); Stefan Warner, Markham (CA); Greg Mihkelson, Toronto (CA)

(73) Assignee: OSRAM SYLVANIA Inc., Wilmington, MA (US)

(21) Appl. No.: 15/058,196

(22) Filed: Mar. 2, 2016

Related U.S. Application Data
(60) Provisional application No. 62/232,756, filed on Sep. 25, 2015.

(51) Int. Cl. H04W 8/00; H04W 76/02; H04W 4/00

(52) U.S. Cl. CPC H04W 8/005; H04W 4/008; H04W 76/023; H04W 84/18

(57) ABSTRACT

Active proximity based wireless network commissioning is provided. Routers and end devices are placed in a default mode before commissioning such that the devices are communicative but do not transmit join requests. A commissioning device is positioned at a selected location and transmits a wireless beacon request that is received by devices within a limited range. Routers, end devices and coordinator devices within range send response beacons. The response beacons are used by the commissioning device to discover devices and select network parameters for the discovered devices. The commissioning device uses the parameters to prompt the coordinator device to form a network and prompt the qualified device to enter a pending mode and join the network.

### CROSS-REFERENCE TO RELATED APPLICATION

The present application claims the benefit of, and priority to, U.S. Provisional Patent Application No. 62/232,756, entitled “ACTIVE PROXIMITY BASED WIRELESS NETWORK COMMISSIONING” and filed Sep. 25, 2015, the entire contents of which are hereby incorporated by reference.

### TECHNICAL FIELD

The present invention relates to wireless networks, and more specifically to wireless network commissioning.

### BACKGROUND

A variety of wireless network technologies have been developed for different types of needs. Examples include cellular networks with ranges up to 30 km, WiFi networks with ranges up to about 20 m, and Bluetooth networks with ranges up to about 10 m. ZigBee is an IEEE 802.15.4 standardized protocol for creating networks of small, low-power digital radios with a range of up to about 100 m. A ZigBee network is comprised of a coordinator, routers, and end devices, where the latter is generally a battery operated device. The coordinator, routers, and end devices may be associated with various types of terminal devices including but not limited to sensors, appliances, lighting fixtures, alarms, industrial controls, and building automation controls. For example, a coordinator, router, or end device may be used to control the on, off, and dim functions of a lighting fixture. An installation site may have multiple networks, and each network may include multiple end devices. Networks may include wireless routers that relay data between end devices and a coordinator device in a network.

### SUMMARY

Network commissioning refers to tasks associated with establishment of one or more networks at an installation site, e.g. causing the correct set of devices to join a particular network and verifying that those devices are functioning properly. Coordinators, end devices, and routers may generate wireless signals that enable mutual detection and communications to establish network associations. However, interference and other problems may be created by wireless signals transmitted by different devices during network commissioning in implementations characterized by one or more of high device count, high device density and proximity of multiple networks.

While aspects are not necessarily associated with particular advantages, embodiments provide for initiating communication and actively searching for qualified devices with a commissioning device rather than having qualified devices initiate communication and actively search for other devices may reduce excess communication traffic due to failed join attempts. Proximity based commissioning may facilitate device identification and commissioning in high device count installations where interference might otherwise be problematic.

In an embodiment, there is provided a method of commissioning a network at a site. The method includes: a qualified device entering a first mode in which the qualified device is communicative and does not transmit join requests; a commissioning device transmitting a wireless beacon request to a subset of all devices to be commissioned at the site; the qualified device and a coordinator device receiving the beacon request and, in response, sending respective response beacons; the commissioning device prompting the coordinator device to form a network; the commissioning device prompting the qualified device to enter a second mode and join the network; and in response to prompting by the commissioning device, the qualified device joining the network formed by the coordinator device.

In a related embodiment, entering the first mode may include forming a PAN (personal area network) consisting of only one device. In a further related embodiment, transmitting the beacon request may include transmitting an interPAN message.

In another related embodiment, the method may include the commissioning device creating a device list based on the response beacons. In a further related embodiment, the method may include the commissioning device interrogating each device in the device list to determine device information and to cause the device to identify itself. In a further related embodiment, the method may include the commissioning device performing diagnostics to determine whether each interrogated device is functioning correctly and is correctly located with reference to a site plan.

In yet another related embodiment, prompting the coordinator device to form a network may include the commissioning device directing the coordinator device to form the network according to specified network parameters.

In still another related embodiment, prompting the qualified device to join the network may include the commissioning device sending network parameters that characterize the network to be joined. In a further related embodiment, entering the second mode may include the qualified device performing background scanning to find the network.

In yet still another related embodiment, the method may include the commissioning device adjusting transmission range.

In another embodiment, there is provided an apparatus to commission a network at a site. The apparatus includes: a commissioning device comprising a processor, non-transitory memory, and an interface that is configured to transmit a wireless beacon request to a subset of all devices to be commissioned at the site; a coordinator device configured to receive the beacon request; a qualified device in a first mode in which the qualified device is communicative and does not transmit join requests, wherein the qualified device is configured to receive the beacon request; wherein the coordinator device and the qualified device are further configured to respond to the beacon request by sending respective response beacons containing information that is used by the processor of the commissioning device to generate a first signal that prompts the coordinator device to form a network and a second signal that prompts the qualified device to enter a second mode and join the network, wherein the qualified device joins the network formed by the coordinator device in response to the second signal.

In a related embodiment, the first mode may include a PAN (personal area network) including a single device. In a further related embodiment, the beacon request may include an interPAN message.

In another related embodiment, the processor may be configured to create a device list based on the response beacons and stores the device list in the memory. In a further related embodiment, the commissioning device may be configured to interrogate each device in the device list to determine device information and to cause the device to identify itself. In a further related embodiment, the commissioning device may be configured to perform diagnostics to determine whether each interrogated device is functioning correctly and is correctly located with reference to a site plan.

In still another related embodiment, the commissioning device may be configured to direct the coordinator device to form the network according to specified network parameters.

In yet another related embodiment, the commissioning device may be configured to send network parameters that characterize the network to be joined. In a further related embodiment, the second mode may include the qualified device performing background scanning to find the network.

In still yet another related embodiment, the commissioning device may be configured to adjust transmission range.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a block diagram of a commissioning device according to embodiments disclosed herein.

FIG. 2 illustrates a site plan according to embodiments disclosed herein.

FIG. 3 is a flow diagram illustrating active, proximity-based wireless network commissioning according to embodiments disclosed herein.

FIGS. 4-7 illustrate stages of active, proximity-based network commissioning overlaid on a site plan according to embodiments disclosed herein.

### DETAILED DESCRIPTION

Some aspects, features, and implementations described herein may comprise computer devices, components, and computer-implemented steps or processes. It should be apparent to those of ordinary skill in the art that the computer-implemented steps or processes may be stored as computer-executable instructions on a non-transitory computer-readable medium. Furthermore, it should be understood by those of ordinary skill in the art that the computer-executable instructions may be executed on a variety of tangible processor devices. For ease of exposition, not every step, process or element is described herein as part of a computer system. Those of ordinary skill in the art will recognize steps, processes, and elements that may have a corresponding computer system or software component. Such computer system and software components are therefore enabled by describing their corresponding steps, processes, or elements, and are within the scope of the disclosure.

To provide context, and without limitation, commissioning of IEEE 802.15.4 based ZigBee PANs (personal area networks) will be described. However, other types of networks could be commissioned in accordance with the aspects described herein. An exemplary PAN is comprised of a coordinator, routers, and end devices, each of which has a unique ID, such as but not limited to a MAC address. Coordinators, routers, and end devices are wireless network nodes that are associated with, or integrated into, any of a wide variety of terminal devices including but not limited to a sensor, appliance, lighting fixture, lighting device, alarm, industrial control, or building automation control. Each PAN has one, and only one, coordinator device. The coordinator device establishes the PAN and stores information about that PAN. The routers relay data between the coordinator device and end devices of the PAN. In some implementations, the end devices are battery powered. Battery life may be conserved by entering a sleep mode and waking at regular intervals or only when communication is necessary. Routers and coordinator devices generally have line power and do not enter sleep mode, however that should not be viewed as a limitation.

Prior to installation at the site, the devices are not necessarily configured to become associated with a specific PAN upon power up. This enables devices of a given type to be used interchangeably. For example, where the locations of devices of each type are predetermined, any end device may be installed in a location that requires an end device, any router may be installed in a location that requires a router, and any coordinator device may be installed in a location that requires a coordinator device. Consequently, a specific end device, router, or coordinator device need not be placed in a specific location. Once the devices have been installed, the commissioning process logically associates the coordinator devices, end devices, and routers with particular PANs and ensures that the end devices and routers have the correct credentials to join the respective PAN.

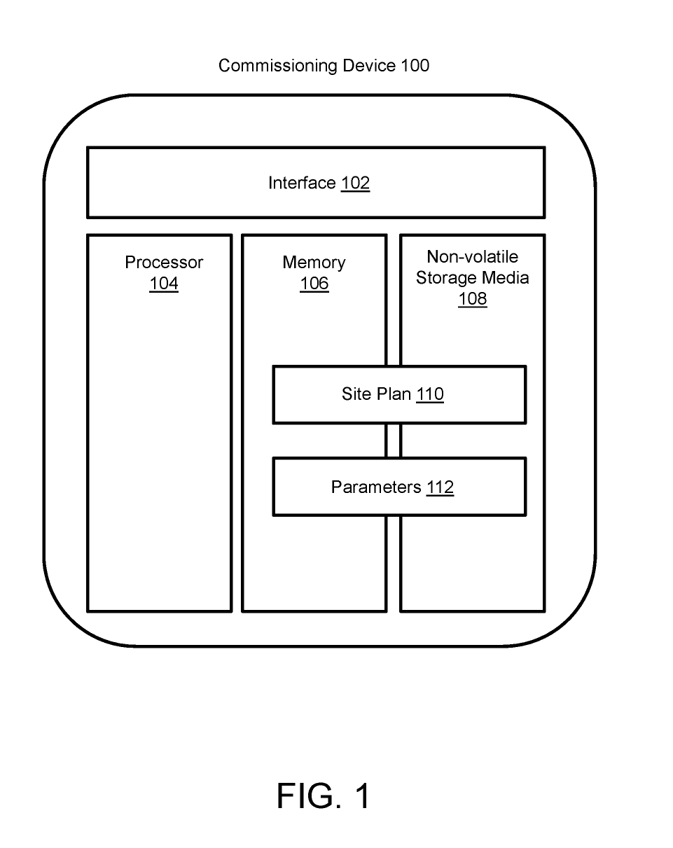

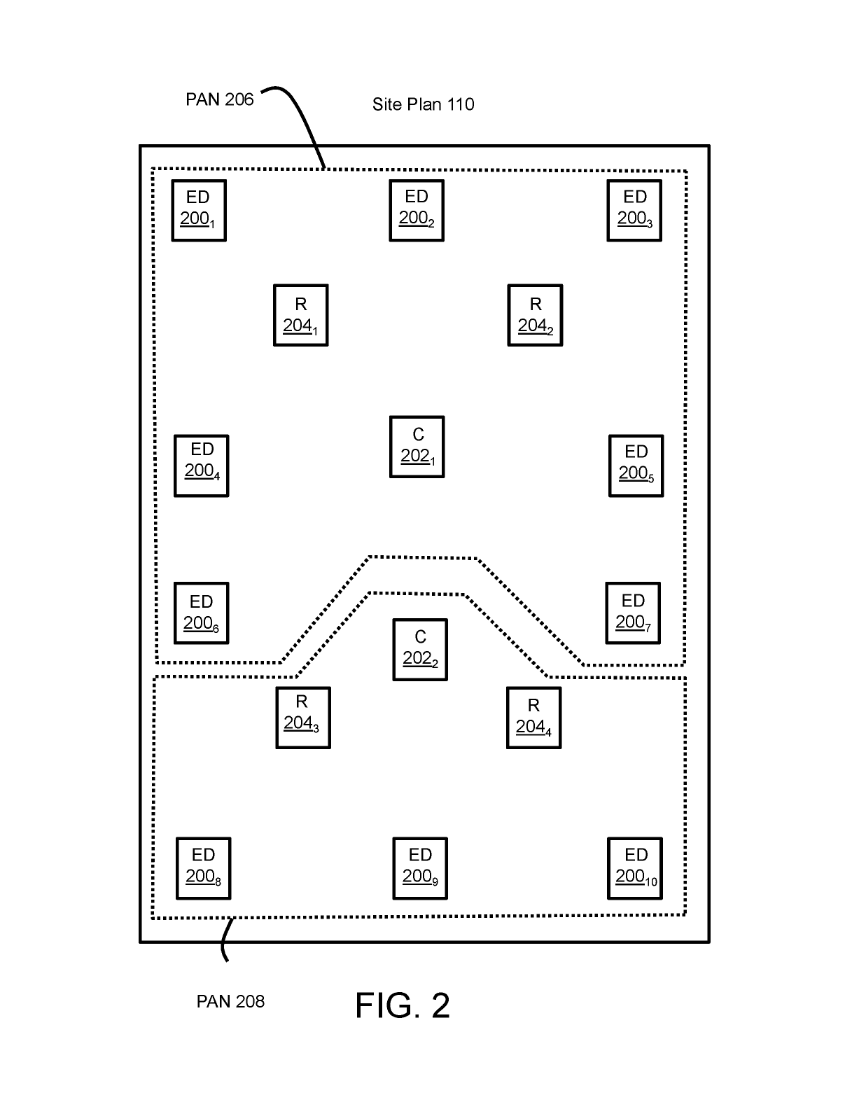

Referring now to FIGS. 1 and 2, a commissioning device 100 is used to commission devices within wireless communication range. The commissioning device 100 is a mobile wireless device with interconnected elements including an interface 102, a processor 104, a memory 106, and a non-volatile storage media 108. The interface 102 may, and in some embodiments does, include both a user interface for user I/O and a wireless interface for communication with other devices, though these are not shown in FIG. 1. Various commissioning data is stored in the commissioning device 100, e.g. in the memory 106 or the non-volatile storage media 108. For example, in some embodiments, a site plan 110 and parameters 112 for one or more PANs is stored in the commissioning device 100. One possible site plan 110 is shown in FIG. 2 and is represented graphically for ease of exposition. However, a wide variety of representations are possible, including various non-graphical representations. The site plan 110 may, and in some embodiments does, include an indication of which types of devices are expected to be found at the site, and also relative locations of those devices. The PAN parameters 112 may, and in some embodiments do, include a record for each device type associated with the site plan 110, including but not limited to an indication of which devices in the site plan 110 should be members of each PAN in a multi-network site. In FIG. 2, the site plan 110 and the network parameters 112 together indicate that end devices (labeled as “ED”) 200₁, 200₂, 200₃, 200₄, 200₅, 200₆, 200₇, and routers (labeled as “R”) 204₁, 204₂, and a coordinator device (labeled as “C”) 202₁ should be part of a PAN 206 and have the relative locations as shown. The site plan 110 and the network parameters 112 also indicate that the end devices ED 200₈, ED 200₉, ED 200₁₀ and the routers R 204₃, R 204₄, and the coordinator device C 202₂ should be part of a PAN 208 and have the relative locations as shown. The network parameters 112 may, and in some embodiments do, include but are not limited to channel mask, link key, extended PAN ID, and PAN ID. However, the network parameters 112 do not necessarily include the unique device identifiers of any of those devices, such as but not limited to device MAC addresses.

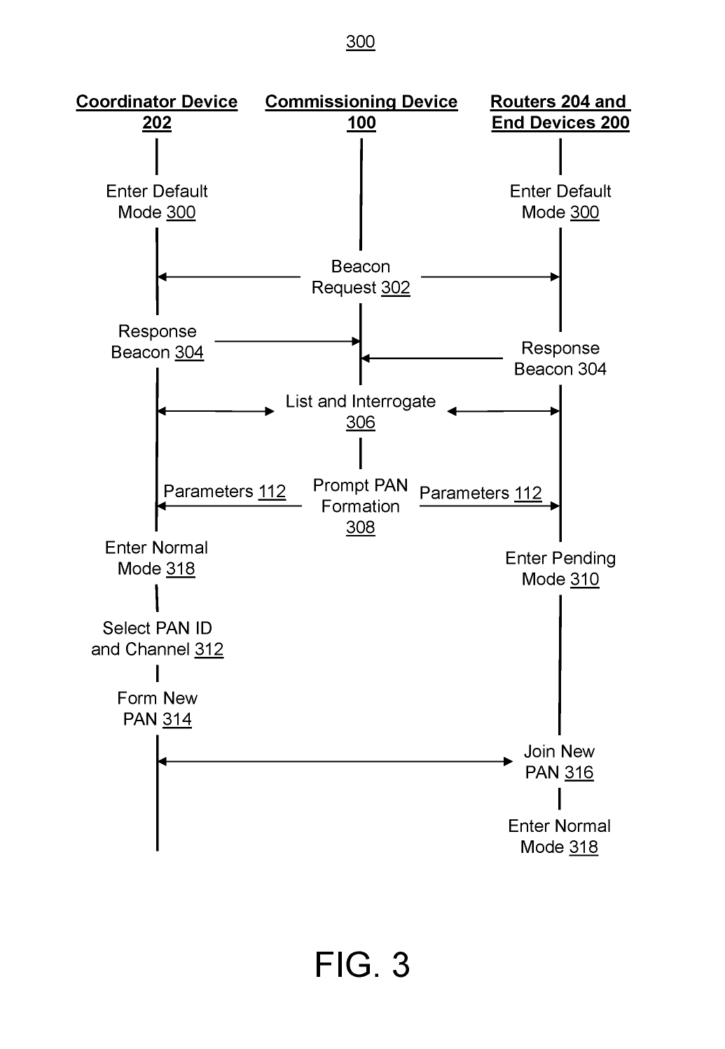

A flow diagram of a method is depicted in FIG. 3. The flow diagram does not depict the syntax of any particular programming language. Rather, the flow diagram illustrates the functional information one of ordinary skill in the art requires to fabricate circuits or to generate computer software to perform the processing required in accordance with embodiments disclosed throughout. It should be noted that many routine program elements, such as initialization of loops and variables, and the use of temporary variables, are not shown. It will be appreciated by those of ordinary skill in the art that unless otherwise indicated herein, the particular sequence of steps described is illustrative only and may be, and in some embodiments is, varied without departing from the spirit of the invention. Thus, unless otherwise stated, the steps described below are unordered meaning that, when possible, the steps may be, and in some embodiments are, performed in any convenient or desirable order.

Further, while FIG. 3 illustrates various operations, it is to be understood that not all of the operations depicted in FIG. 3 are necessary for embodiments to function. Indeed, it is fully contemplated herein that in some embodiments of the present disclosure, the operations depicted in FIG. 3, and/or other operations described herein, may be and are combined in a manner not specifically shown in any of the drawings, but still fully within the scope of the present disclosure. Thus, claims directed to features and/or operations that are not exactly shown in one drawing are deemed within the scope and content of the present disclosure.

Turning now to FIG. 3, in a preparatory step for a commissioning process 300, the coordinator devices (collectively 202), the routers (collectively 204), and the end devices (collectively 200) enter a default mode as indicated at 300. In the default mode, the coordinator devices 202, the routers 204, and the end devices 200 each form their own commissioning network on a commissioning channel. This may be, and in some embodiments is, done automatically upon power up after installation of the end devices 200, the coordinator devices 202, and the routers 204 at the site. Each commissioning network may be, and in some embodiments is, a PAN having only a single device (itself) as a member. The extended PAN ID is set to a value, such as but not limited to the unique ID of the radio (eui64), and the PAN ID is set to a related value, such as but not limited to the lower 16 bits of the unique ID of the radio (eui64). All devices are discoverable on the commissioning channel once they form their respective commissioning network. The extended PAN ID enables the commissioning device 100 to identify each device according to their eui64. In the default mode, the coordinator devices 202, the routers 204, and the end devices 200 are in a communicative state in which they may receive and respond to interPAN messages. However, any devices in the communicative state do not transmit join request messages to announce or attempt to join PANs. A 100% communicative state duty cycle is, in some embodiments, associated with the default mode, for example and without limitation.

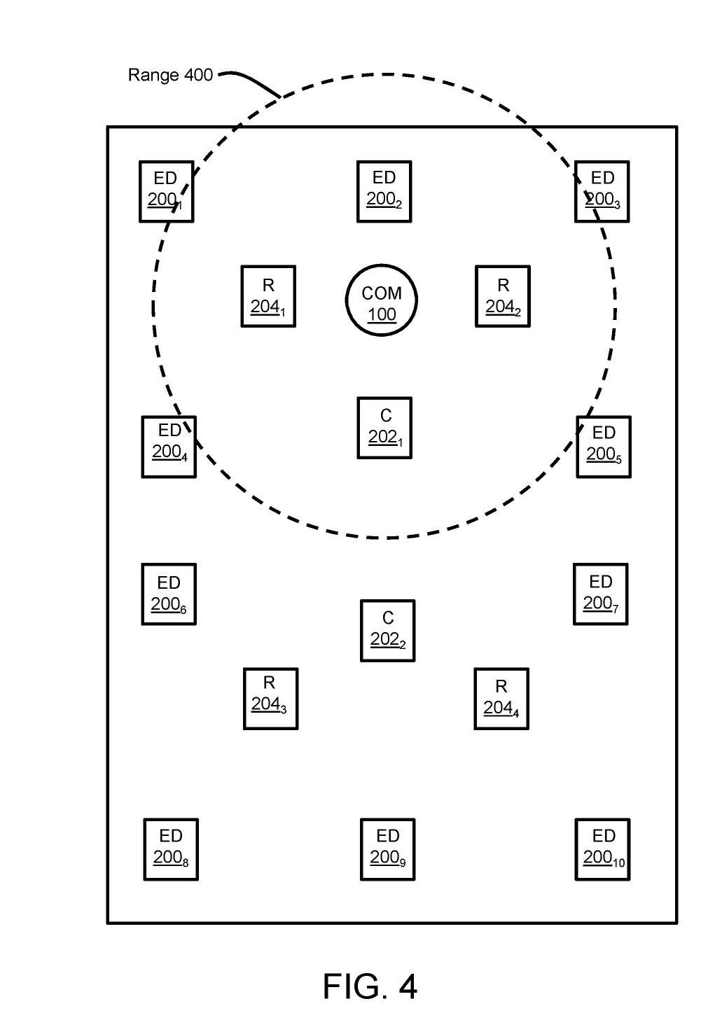

Referring now to FIG. 4 as well as FIG. 3, the commissioning device 100 is transported to a selected location at the actual site (as represented by FIG. 4) in order to commence network commissioning. Commissioning is proximity based, and multiple different commissioning locations may be selected and used, e.g. in sequence. The commissioning device remains stationary at a particular location while performing commissioning within radio range of that location. In response to user input, the commissioning device 100 transmits one or more beacon requests 302. The beacon request is an interPAN message. Based on the location and transmit range 400 of the commissioning device (labelled in FIG. 4 as “COM”) 100, the beacon request is received by the coordinator device C 202₁, the routers R 204₁, R 204₂ and the end devices ED 200₁, ED 200₂, ED 200₃, ED 200₄, ED 200₅. The receiving coordinator device 202, routers 204, and end devices 200 respond to the beacon request 302 by transmitting response beacons 304. The response beacons are received by the commissioning device 100/COM 100. Thus, the commissioning device 100/COM 100 discovers the devices within the range 400 based on the response beacons 304. The commissioning device 100 uses the response beacons to create a list of the devices that sent response beacons and also interrogates each responding device as indicated at 306. The commissioning device 100 may, and in some embodiments does, send interPAN messages to each responding device to determine device information and to cause the corresponding device to identify itself through an actuator as part of interrogation 306. Based on the signal strength of the response beacons, indicated device type, and the stored site plan 110 (see FIG. 1), the commissioning device COM 100 calculates its location and the relative locations of the responding devices on the site plan 110. After the commissioning device COM 100 calculates its location and the relative locations of other devices on the stored site plan 110, the commissioning device COM 100 associates individual responding devices in the list with corresponding devices in the site plan 110, e.g. by finding the closest match between the calculated locations and the locations indicated in the stored site plan 110. Diagnostics may be, and in some embodiments are, performed to determine whether each responding device is functioning correctly and is in the correct location as indicated in the site plan 110. The commissioning device COM 100 may, and in some embodiments does, adjust the transmit power, and thus the range 400, in order to prompt beacon responses from more or fewer devices. For example, if the number of received beacon responses are inadequate to calculate device locations on the site plan 110, then the range is increased in order to obtain response beacons from more devices. The commissioning device COM 100 may, and in some embodiments does, reduce the transmit power on the beacon request message in order to improve device localization and facilitate device identification.

When interrogation and diagnostics 306 are complete, the commissioning device 100 prompts PAN formation by signaling to the responding devices as indicated at 308. Using interPAN messaging, the commissioning device 100 (in the example shown in FIG. 4, the commissioning device COM 100) directs the coordinator device 202 (in the example shown in FIG. 4, the coordinator device C 202₁) to form a PAN with the specified network parameters 112. The coordinator device 202 then enters a normal mode as indicated at 318. The routers 204 (in the example shown in FIG. 4, the routers R 204₁, 204₂) are directed by the commissioning device COM 100 through interPAN messages to join a network with the specified network parameters 112. Each of the routers 204 and the end devices 200 then enters a pending mode as indicated at 310.

In the pending mode 310, each router 204 and end device 200 continues to operate in its single member network while performing background scanning of all available channels for a PAN that matches the received parameters. For example, the pending mode may have a 95% communicative state duty cycle. The router 204 or the end device 200 attempts to associate with each discovered PAN that matches the parameters. A search timer may be, and in some embodiments is, used to limit the amount of time in which the devices attempt to find and join a network without success. If the router 204 or the end device 200 is unable to successfully join a PAN within the timer period, it returns to its single member network and awaits messages from the commissioning device 100. The commissioning device 100 may, and in some embodiments does, communicate with a router 204 in the pending state. For example, the commissioning device 100 in some embodiments causes the router 204 or the end device 200 to identify itself, and the commissioning device 100 sends new network parameters.

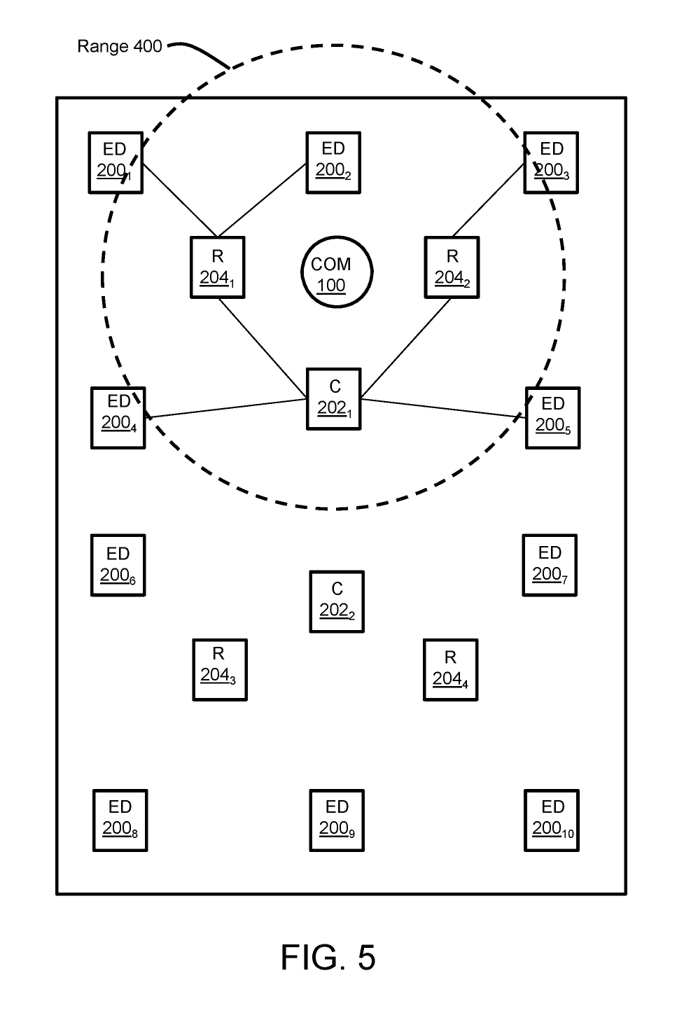

Upon entering the normal mode 318, the coordinator device 202 selects a PAN ID (if not specified in the specified network parameters 112) and operating channel for the PAN as indicated at 312. The coordinator device 202 then forms a new PAN as indicated at 314. The routers 204 and the end devices 200 join the new PAN when they discover it as indicated at 316. Once the routers 204 and the end devices 200 join the PAN, they enter the normal mode as indicated at 318. In the normal mode, each router 204 and end device 200 terminates its respective single member network and background scanning of other channels. Links in the wireless mesh network are established in accordance with standard techniques of the protocol. The resulting partially commissioned PAN corresponding to the PAN 206 shown in FIG. 2 is shown in FIG. 5. The PAN shown in FIG. 5 is partially commissioned, because the end devices ED 200₆ and ED 200₇ are out of the range 400 and thus are still operating in the default mode.

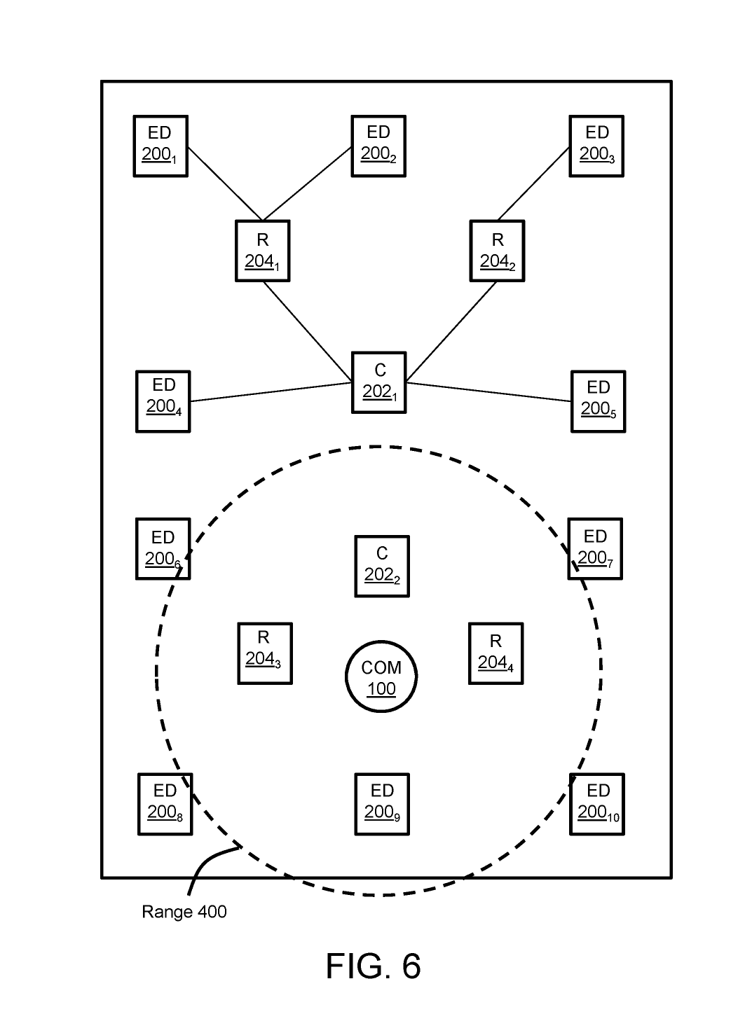

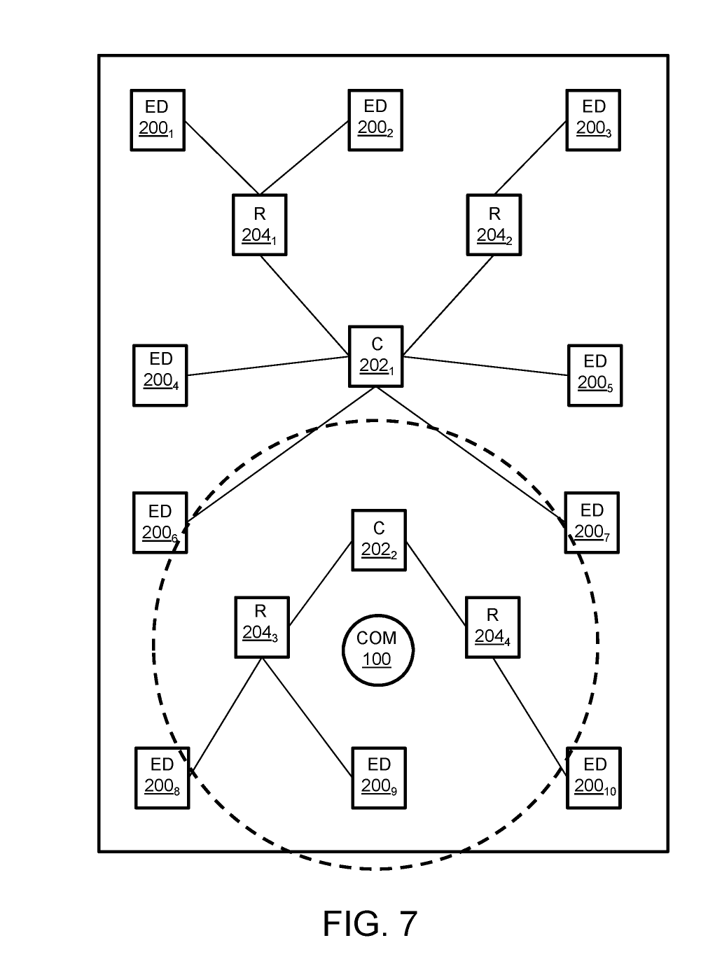

Referring to FIGS. 3 and 6, the commissioning device 100 (in regards to FIG. 3)/COM 100 (in regards to FIG. 6) is next moved to another selected location at the site and the commissioning procedure 300 is repeated. In response to user input, the commissioning device 100 transmits a beacon request 302. The beacon request is received by the coordinator device C 202₂, the routers R 204₃, R 204₄, and the end devices ED 200₆, ED 200₇, ED 200₈, ED 200₉, ED 200₁₀, within a radio communication range 400 of the new location of the commissioning device COM 100. The range 400 may be, and in some embodiments is, adjusted as already described above. The coordinator device 202, the routers 204, and the end devices 200 within radio communication range of the commissioning device 100 respond to the beacon request 302 by transmitting response beacons 304. The response beacons are received by the commissioning device 100, and the coordinator device 202, the routers 204, and the end devices 200 within the range 400 are thereby discovered. The commissioning device 100 then calculates its location and the relative locations of the responding devices on the site plan 110, and creates the list and performs interrogations as indicated at step 306. The commissioning device 100 then prompts PAN formation at 308 by signaling to the responding devices. For example, the specified network parameters 112 associated with the site plan 110 may be, and in some embodiments are, transmitted to the coordinator device 202 that sent the response beacon 304 in reply to the discovery beacon 302. Each of the responding routers 204 and end devices 200 may also be, and in some embodiments are, provided with the specified parameters 112. Different parameters may be, and in some embodiments are, sent to the routers 204 and the end devices 200 based on PAN association. For example, the end devices ED 200₆, ED 200₇ that are associated with the PAN 206 of FIG. 2 according to the site plan 110 are sent different parameters than the coordinator device C 202₂, the routers R 204₃, R 204₄ and the end devices ED 200₈, ED 200₉, ED 200₁₀, which are associated with the PAN 208 of FIG. 2 according to the site plan 110. Each of the routers 204 and the end devices 200 then enters a pending mode as indicated at 310. The coordinator device 202 responds to the specified parameters 112 by entering the normal mode 318, and selecting a PAN ID (if not specified in the parameters 112) and operating channel for the PAN 208 of FIG. 2 as indicated at 312. The coordinator device 202 then forms the new PAN as indicated at 314. The routers 204 and the end devices 200 join the respective PAN (i.e., the PAN 208 of FIG. 2) indicated by the specified parameters 112 when they discover it as indicated at 316. Once the routers 204 and the end devices 200 join the respective PAN, they enter the normal mode as indicated at 318. Links in the wireless mesh network are established in accordance with standard techniques of the protocol. The resulting PANs corresponding to the PAN 206 and the PAN 208 of FIG. 2 are shown in FIG. 7.

Joined devices remain on their respective PANs until either instructed to leave or until the respective PAN is no longer viable. Upon leaving the respective PAN, the router or end device re-enters the pending mode and reforms its commissioning network.

In some embodiments, the commissioning devices are pre-loaded with the specified parameters 112 before commissioning. The commissioning devices, routers, and end devices may still be prompted to form PAN associations by the commissioning device. However, the prompt signal would not necessarily include the parameters. For example, the coordinator devices could form the new PAN based on pre-loaded parameters and then discover the routers and end devices.

The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, flash memory, solid state drive, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), personal area network (PAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s) or smart cellphone(s), tablet(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A method of commissioning a network at a site, comprising:
a qualified device entering a first mode in which the qualified device is communicative and does not transmit join requests;
a commissioning device transmitting a wireless beacon request to a subset of all devices to be commissioned at the site;
the qualified device and a coordinator device receiving the beacon request and, in response, sending respective response beacons;
the commissioning device prompting the coordinator device to form a network;
the commissioning device prompting the qualified device to enter a second mode and join the network; and
in response to prompting by the commissioning device, the qualified device joining the network formed by the coordinator device.

2. The method of claim 1, wherein entering the first mode comprises forming a PAN (personal area network) consisting of only one device.

3. The method of claim 2, wherein transmitting the beacon request comprises transmitting an interPAN message.

4. The method of claim 1, comprising the commissioning device creating a device list based on the response beacons.

5. The method of claim 4, comprising the commissioning device interrogating each device in the device list to determine device information and to cause the device to identify itself.

6. The method of claim 5, comprising the commissioning device performing diagnostics to determine whether each interrogated device is functioning correctly and is correctly located with reference to a site plan.

7. The method of claim 1, wherein prompting the coordinator device to form a network comprises the commissioning device directing the coordinator device to form the network according to specified network parameters.

8. The method of claim 1, wherein prompting the qualified device to join the network comprises the commissioning device sending network parameters that characterize the network to be joined.

9. The method of claim 8, wherein entering the second mode comprises the qualified device performing background scanning to find the network.

10. The method of claim 1, comprising the commissioning device adjusting transmission range.

11. An apparatus to commission a network at a site, the apparatus comprising:
a commissioning device comprising a processor, non-transitory memory, and an interface that is configured to transmit a wireless beacon request to a subset of all devices to be commissioned at the site;
a coordinator device configured to receive the beacon request;
a qualified device in a first mode in which the qualified device is communicative and does not transmit join requests, wherein the qualified device is configured to receive the beacon request;
wherein the coordinator device and the qualified device are further configured to respond to the beacon request by sending respective response beacons containing information that is used by the processor of the commissioning device to generate a first signal that prompts the coordinator device to form a network and a second signal that prompts the qualified device to enter a second mode and join the network, wherein the qualified device joins the network formed by the coordinator device in response to the second signal.

12. The apparatus of claim 11, wherein the first mode comprises a PAN (personal area network) comprising a single device.

13. The apparatus of claim 12, wherein the beacon request comprises an interPAN message.

14. The apparatus of claim 11, wherein the processor is configured to create a device list based on the response beacons and stores the device list in the memory.

15. The apparatus of claim 14, wherein the commissioning device is configured to interrogate each device in the device list to determine device information and to cause the device to identify itself.

16. The apparatus of claim 15, wherein the commissioning device is configured to perform diagnostics to determine whether each interrogated device is functioning correctly and is correctly located with reference to a site plan.

17. The apparatus of claim 11, wherein the commissioning device is configured to direct the coordinator device to form the network according to specified network parameters.

18. The apparatus of claim 11, wherein the commissioning device is configured to send network parameters that characterize the network to be joined.

19. The apparatus of claim 18, wherein the second mode comprises the qualified device performing background scanning to find the network.

20. The apparatus of claim 11, wherein the commissioning device is configured to adjust transmission range.
